(19) United States
(12) Patent Application Publication
(10) Pub. No.: US 2017/0229215 A1
(43) Pub. Date: Aug. 10, 2017

(54) ELECTRICAL CABLE

(71) Applicant: Christoph Studer, Gretzenbach (CH)

(72) Inventor: Christoph Studer, Gretzenbach (CH)

(21) Appl. No.: 15/503,063

(22) PCT Filed: Aug. 10, 2015
(86) PCT No.: PCT/EP2015/068394

§ 371 Date: Feb. 10, 2017

(30) Foreign Application Priority Data
Aug. 11, 2014 (CH) 01213/14

(51) Int. Cl. H01B 9/04; H01B 9/00

(52) U.S. Cl. CPC H01B 9/04; H01B 9/003; H01B 9/006; H01B 1/026

(57) ABSTRACT

The invention relates to an electrical cable for supplying aircraft and similar devices with alternating current having at least partially higher frequencies of preferably 400 Hz. The cable is provided with a central neutral and/or return conductor (1) and at least six phase conductors (2a, 2b, 3a, 3b, 4a, 4b) arranged in a concentrically distributed manner about same, wherein every phase is distributed on two symmetrically opposing phase conductors (2a, 2b, 3a, 3b or 4a, 4b). The neutral and/or return conductor (1) is formed, in a very space-saving manner and with low inductivity, by preferably six individually insulated compact neutral wires (16), the total cross-section of which approximately corresponds to the cross-section of an individual solid neutral wire. In this way, with six-fold redundancy, the risk of a neutral wire failure is reduced, without diminishing the electrical properties with the inductive voltage drop.

The invention relates to an electrical cable for supplying electricity to an aircraft, an engine or similar, for at least partially higher frequencies of preferably 400 Hz, comprising a central neutral and/or return conductor and at least six phase conductors arranged in a concentrically distributed manner about the latter.

Such electrical cables are used for the conveyance of large currents with high frequencies in aircraft and in the ground. By means of the overall symmetrical structure and the phase construction distributed over two conductors, they also have symmetrical and optimally reduced inductive voltage drops with a minimised skin effect, and so are used especially for longer stretches. In aircraft in particular the supply of electricity with high-frequency current is well known to offer the advantage that as a result, lighter generators, engines and similar, in particular inductively acting components and equipment can be used in the aircraft.

With the previously known electrical cables of this type the neutral and/or return conductor is made in the form of a one-part, solid or flexible neutral wire, the symmetrical structure of the cable meaning that the neutral wire is guided in the centre of the cable. These known electrical cables totally satisfy the requirements if they are laid in a fixed manner.

When using the cable as a flexible service cable, as is the case when using the same as an electrical supply cable for aircraft, when not being used they are rolled up on reels or upon docking they are unrolled by the aircraft and are then pulled over the asphalt surface or similar. The case then arises where there is an active single conductor in the middle of the cable which is subjected to strong mechanical loading due to torsion because the supply cable is subjected recurrently to bending stress due to the repeated rolling up and unrolling.

This results in the risk of the neutral and/or return conductor of the cable being damaged by the strong bending stress, and so the cable becomes inoperable. In the past attempts have been made to compensate for this disadvantage by a mechanically reinforced core in the central neutral wire. However, this type of construction may nevertheless lead to breakage of the central conductor depending on the loading and life span of the cable, but at a later point in time than with comparable electrical cables with an unreinforced central conductor.

With generic cables the neutral conductor generally only has half the cross-section of the phase conductors (each with 2 phases). In particular, since single-phase asymmetrical consumers with connected power supplies on board bring about an addition to the harmonic waves that are generated in the neutral conductor, the skin effect, and so the loading, is disadvantageously increased in the latter.

The object underlying the invention is to devise an electrical cable of the type specified at the start and which has optimal flexibility and resistance to torsion, but nevertheless guarantees optimal electrical values without the risk of breakage of the central neutral and/or return conductor. Furthermore, the disadvantageous skin effect in the neutral or return conductor should be reduced while retaining the same diameter of the neutral conductor.

According to the invention this object is achieved by the neutral and/or return conductor being made up of a number of individually insulated neutral wires, the total cross-section of which approximately corresponds to the cross-section of an individual solid central conductor.

By means of this construction a structure of the cable centre is produced with only one loadable, non-electrical central element by means of which better mechanical properties are produced, without the cable centre with all of the neutral conductors becoming thicker than with conventional constructions. As a result, the phase insulation does not have to be unnecessarily thicker in order to fulfil the geometric dimensions for the layer stranding.

By means of the construction of the cable according to the invention it is also possible, despite the multi-part structure of the central neutral conductor, to retain the small inductivity covering, i.e. to guarantee a compact conductor construction. Specifically with 3-phase alternating currents with 400 Hz this is very important because each increase in inductivity brings about an 8 times higher inductive voltage drop than would be the case with 50 Hz currents. With a respectable proportion of harmonic waves as a result of static converters or electronic consumers, the importance in this regard increases once again.

At the same time the new cable construction allows redundancy of the central neutral and/or return conductor since with the latter, unlike with conventional constructions with only one solid neutral wire, it is practically out of the question that all six single conductors of the multi-part neutral wire can break at the same time. As a result, the risk of a neutral wire breakage is therefore very greatly reduced because there is no longer an active conductor in the centre of the electrical cable and multiple redundancy is effective.

Further advantageous embodiments of the invention are characterised in the other sub-claims.

In the following the invention is described in more detail by means of an exemplary embodiment with reference to the drawings. This shows:

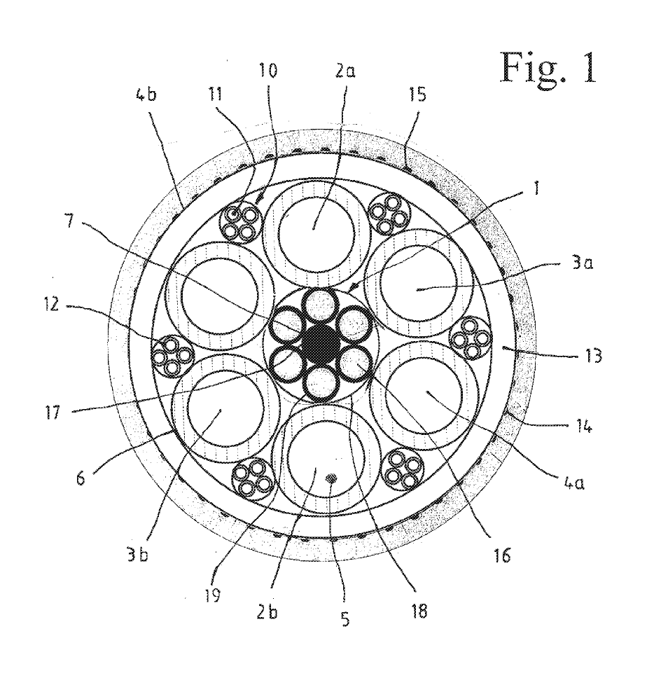

FIG. 1 is a cross-section of an electrical cable according to the invention.

The electrical cable shown in FIG. 1 has a central combination of wires as the neutral and/or return conductor 1 as well as six phase conductors 2a, 2b, 3a, 3b, 4a, 4b arranged evenly in a concentrically distributed manner about the latter, each phase being distributed over two symmetrically opposing phase conductors 2a, 2b, 3a, 3b, or 4a, 4b.

The six phase conductors 2a to 4b have, for example, a cross-section of 35 mm² and are produced from bare and fine-wired copper strands 5. These copper strands 5 are designed according to the IEC 60228 standard, at least class 5, each phase conductor being provided with insulation 6 composed of preferably cross-linked plastic insulation, for example EPR.

Furthermore, the electrical cable is equipped with an inner sheath 13 made of orange-coloured polyurethane as a wear indicator, and an outer sheath 14 made of yellow-coloured polyurethane with fibre reinforcement 15 lying in between. Needless to say, other colours could also be used.

According to the invention the electrical cable is made up from six individually insulated neutral wires 16 each with individual insulation 19, the neutral wires 16 and also the phase conductors 2a, 2b, 3a, 3b, 4a, 4b each being formed from a plurality of wires.

Advantageously, the neutral wires 16 are made with SRC (Special Round Conductor) cores or Unilay strands, each with a cross-section of 6 mm², i.e. a total of 36 mm², and this corresponds to the cross-section of a conventional, non-distributed neutral wire.

With a known solid neutral wire a number of strands are generally wound like a cable around a centre, which strands are produced, cross-linked, from copper strands 8, bare and fine-wired, with insulation 9 made of EPR.

The individual neutral wires 16 of the distributed neutral and/or return conductor 1 are arranged about a central element 17 made of plastic material and have a thin casing 18 or banding encompassing them, also made of insulating material. The neutral wires 16 are produced from fine-wired copper strands and are individually insulated with thin-walled and electron beam cross-linked insulation 19 made of a preferably cross-linked plastic, for example a polyolefin copolymer.

By means of the structure according to the invention of the central neutral and/or return conductor 1, in comparison to the prior art the risk of breakage of the central conductor can be greatly reduced without changing the overall cross-section of the cable and having any negative impact upon its excellent electrical properties. Since in practice not all six individual neutral wires 16 can break at the same time, multiple redundancy of the neutral wire distributed according to the invention is produced, and this is associated with a strong reduction of the risk of a neutral wire breakage, especially as there is no active conductor in the geometric centre of the cable.

Within the framework of the invention the electrical cable comprises outer thin cables 10 additionally distributed evenly around the circumference on the outside between the adjacent phase conductors 2a, 2b, 3a, 3b, 4a, 4b, which have conductors 11 in fours each being 4×1 mm² and which are also provided as fine-wired copper strands each with insulation 12 which is in turn preferably made of cross-linked plastic insulation.

Advantageously the stranding direction of the insulated neutral wires 16 is to be chosen to be the same as that of the phase conductors 2a, 2b, 3a, 3b, 4a, 4b. The lay lengths are to be determined in relation to one another here such that with torsion, the length changes of the neutral wires lying on the inside are approximately the same as those of the outer phase conductors.

As a variation, additional neutral wires can be contained in the outer thin cables of the cable, by means of which a further increase of the overall cross-section of the neutral and/or return conductor is made possible, for example over the full phase cross-section.

1. An electrical cable for supplying electricity to an aircraft, an engine or similar, for at least partially higher frequencies of preferably 400 Hz, comprising a central neutral and/or return conductor (1) and at least a number of phase conductors (2a, 2b, 3a, 3b, 4a, 4b) arranged in a concentrically distributed manner about the latter, characterised in that the central neutral and/or return conductor (1) is made up of a number of neutral wires (16) each with individual insulation (19), the neutral wires (16) and the phase conductors (2a, 2b, 3a, 3b, 4a, 4b) each being formed from a plurality of wires.

2. The electrical cable according to claim 1, characterised in that the number of, preferably six, neutral wires (16) are arranged about a non-electrically conductive central element (17).

3. The electrical cable according to claim 1, wherein the neutral wires (16) are each produced from one or more strands with a high degree of filling from the thin wires with a copper structure.

4. The electrical cable according to claim 3, characterised in that the respective neutral wires (16) are produced from SRC strands or Unilay strands.

5. The electrical cable according to claim 1, wherein the neutral wires (16) are made of twisted wires with a diameter of between 0.05 mm and 0.75 mm.

6. The electrical cable according to claim 1, wherein the respective neutral wires (16) are made of bunched strands without a geometric structure, each with a plurality of wires, for example between 700 and 800 with a cross-section of 6 mm², and these are surrounded by a film as insulation (19).

7. The electrical cable according to claim 1, wherein the neutral wires (16) are each provided with very thin and cross-linked insulation (19) made of plastic and which has a wall thickness of 0.1 mm to 1 mm.

8. The electrical cable according to claim 1, wherein at least one outer thin cable (10) each with a number of conductors (11) are respectively guided on the outside between the adjacent phase conductors (2a, 2b, 3a, 3b, 4a, 4b).

9. The electrical cable according to claim 8, characterised in that preferably four conductors (11), each provided with insulation (12), can respectively be used for measuring, control and/or regulation purposes.

10. The electrical cable according to claim 1, wherein the phase conductors (2a, 2b, 3a, 3b, 4a, 4b), that are each distributed over two symmetrically opposing phase conductors (2a, 2b, 3a, 3b or 4a, 4b), and the additional conductors (11) are enclosed by an inner sheath (13) made of a coloured plastic surrounding the latter and an outer sheath (14) surrounding the latter made of a plastic of a different colour.

11. The electrical cable according to claim 1, wherein the stranding direction of the neutral wires (16) runs in the same direction as that of the phase conductors (2a, 2b, 3a, 3b, 4a, 4b).

12. The electrical cable according to claim 11, characterised in that the lay lengths are determined in relation to one another such that with torsion the length changes of the neutral wires (16) lying on the inside are approximately the same as those of the phase conductors (2a, 2b, 3a, 3b, 4a, 4b).

13. The electrical cable according to claim 2, wherein the neutral wires each comprise at least one strand having a high degree of filling and from thin wires with a copper structure.

14. The electrical cable according to claim 13, wherein the respective neutral wires are produced from SRC strands or Unilay strands.

15. The electrical cable according to claim 2, wherein the respective neutral wires are made of bunched strands without a geometric structure, each with a plurality of wires, and surrounded by a film as insulation.

16. The electrical cable according to claim 15, wherein at least one outer thin cable each with a number of conductors are respectively guided on the outside between the adjacent phase conductors.

17. The electrical cable according to claim 2, wherein at least one outer thin cable each with a number of conductors are respectively guided on the outside between the adjacent phase conductors.

18. The electrical cable according to claim 2, wherein the neutral wires are each provided with thin and cross-linked insulation made of plastic and which has a wall thickness of 0.1 mm to 1 mm.

19. The electrical cable according to claim 18, wherein at least one outer thin cable each with a number of conductors are respectively guided on the outside between the adjacent phase conductors.

20. The electrical cable according to claim 3, wherein at least one outer thin cable each with a number of conductors are respectively guided on the outside between the adjacent phase conductors.
